(19) United States
(12) Patent Application Publication
(10) Pub. No.: US 2025/0050938 A1
(43) Pub. Date: Feb. 13, 2025

(54) BEVELED SNAP RING FOR RACK ELECTRIC POWER STEERING SYSTEM

(71) Applicant: Steering Solutions IP Holding Corporation, Saginaw, MI (US)

(72) Inventors: Yubing Xie, Suzhou (CN); Jay Zhao, Suzhou (CN); Peng Mi, Suzhou (CN); Yamei Zhou, Suzhou (CN)

(21) Appl. No.: 18/459,736

(22) Filed: Sep. 1, 2023

(30) Foreign Application Priority Data
Aug. 11, 2023 (CN) 202311014239X

(51) Int. Cl. B62D 5/04

(52) U.S. Cl. CPC B62D 5/0403

(57) ABSTRACT

A vehicle steering assembly includes a rack which is translatable and disposed within a rack housing. The vehicle steering assembly also includes a pinion shaft operatively coupled to the rack. The vehicle steering assembly further includes a bearing in contact with the pinion shaft and disposed within the rack housing. The vehicle steering assembly yet further includes a snap ring partially disposed within a groove defined by the rack housing, the snap ring in contact with the bearing in a first condition, the snap ring having an ear portion defining a hole, wherein the snap ring is moveable from the first condition to a second condition, the first condition pressing the bearing to hold the bearing in place, the second condition allowing the bearing to be removed from the rack housing.

### CROSS-REFERENCE TO RELATED APPLICATION

This application claims the benefits of priority to Chinese Patent Application No. 202311014239X, filed Aug. 11, 2023, the disclosure of which is incorporated by reference herein in its entirety.

### FIELD OF THE INVENTION

The present disclosure relates to electric power steering systems for vehicles and, more particularly, to a beveled snap ring for rack electric power steering systems.

### BACKGROUND

An electric power steering (EPS) system is used to supplement a steering torque input that an operator of a vehicle applies to a steering wheel of the vehicle. The EPS system has a controller (e.g. an electronic control unit) which calculates an assist force needed based on the steering torque input, a steering wheel position, and a speed of the vehicle. The EPS system also has an electric motor that rotates a steering gear with the calculated assist force to control vehicle steering operations, thereby providing an improved steering experience to the operator.

A lower rotor assembly of the EPS system includes a lower rotor and a probe housing assembly (PHA). The PHA may include a plastic member and a printed circuit board (PCB) coupled to the plastic member. The lower rotor is coupled to a pinion shaft assembly in a rack EPS configuration, with the pinion shaft assembly being at least partially guided by a bearing. A snap ring is provided to retain the bearing in place within a rack housing. However, it is difficult to disassemble the pinion shaft assembly from the rack EPS since the snap ring is below the lower rotor and the PHA. The conventional arrangement of parts leaves little to no space to take out the snap ring without destroying the PHA. The snap ring can be removed after the lower rotor and an upper rotor are removed from the pinion shaft, but the PHA and possibly the rotors must be replaced by new components after maintenance or replacement is made for the snap ring. Accordingly, an assembly that avoided the need for replacement of additional parts during disassembly would be desirable.

### SUMMARY OF THE DISCLOSURE

According to one aspect of the disclosure, a vehicle steering assembly includes a rack which is translatable and disposed within a rack housing. The vehicle steering assembly also includes a pinion shaft operatively coupled to the rack. The vehicle steering assembly further includes a bearing in contact with the pinion shaft and disposed within the rack housing. The vehicle steering assembly yet further includes a snap ring partially disposed within a groove defined by the rack housing, the snap ring in contact with the bearing in a first condition, the snap ring having an ear portion defining a hole, wherein the snap ring is moveable from the first condition to a second condition, the first condition pressing the bearing to hold the bearing in place, the second condition allowing the bearing to be removed from the rack housing.

According to another aspect of the disclosure, a vehicle steering assembly includes a rack which is translatable and disposed within a rack housing. The vehicle steering assembly also includes a pinion shaft operatively coupled to the rack. The vehicle steering assembly further includes a bearing in contact with the pinion shaft and disposed within the rack housing. The vehicle steering assembly yet further includes a snap ring partially disposed within a groove defined by the rack housing, the snap ring in contact with the bearing in a first condition, the snap ring including a beveled portion in contact with an outer race of the bearing.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a rack electric power steering system;

FIG. 2 is a cross-sectional view of the rack electric power steering system at a pinion shaft and bearing interface with a snap ring;

FIG. 3 is an enlarged view of a portion of FIG. 2 illustrating the snap ring interface with the bearing;

FIG. 4 is a perspective view of the snap ring;

FIG. 5 is a cross-sectional view of the rack electric power steering system with the snap ring in an installed position; and

FIG. 6 is a cross-sectional view of the rack electric power steering system with the snap ring opening for disassembly.

### DETAILED DESCRIPTION

Referring now to the Figures, where the invention will be described with reference to specific embodiments, without limiting same, an electric power steering (EPS) steering system is disclosed. More particularly, the EPS system includes a sub-assembly that can be disassembled without requiring replacement of components.

The embodiments described herein are used in conjunction with a steering system of a vehicle, such as a car, truck, sport utility vehicle, crossover, mini-van, marine craft, aircraft, all-terrain vehicle, recreational vehicle, or other suitable vehicles which include various steering system schemes.

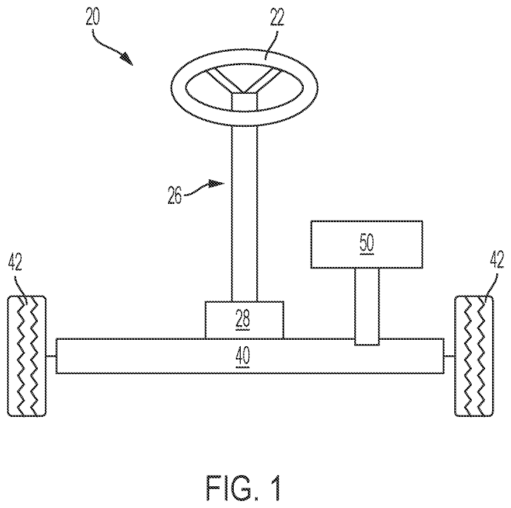

Referring initially to FIG. 1, a power steering system 20 is generally illustrated. The power steering system 20 may be configured as a driver interface steering system, an autonomous driving system, or a system that allows for both driver interface and autonomous steering. The steering system may include an input device 22, such as a steering wheel, wherein a driver may mechanically provide a steering input by turning the steering wheel. A steering column 26 extends along an axis from the input device 22 to an output assembly 28. The steering column 26 includes one or more jackets. The embodiments disclosed herein are utilized in steering systems where the output assembly 28 is in operative communication with a linear translating component 40, which is a rack in some embodiments. The output assembly 28 is a pinion shaft in contact with the rack 40 and may be referred to as either the output assembly or the pinion shaft. The rack 40 pivots the steering wheels 42 to steer the vehicle. One or more sensors detect an angle and torque of steering column components associated with steering inputs provided by the operator. An ECU may receive the sensor inputs and electronically communicate an assist force to be applied to the rack 40 with an assist mechanism 50 so as to reduce the steering torque input required from the operator.

While the illustrated embodiments show a rack electric power steering (REPS) system, where the electromechanical assistance is provided to a portion of the rack structure, it is to be appreciated that the embodiments disclosed herein may be applicable to a steer-by-wire steering system.

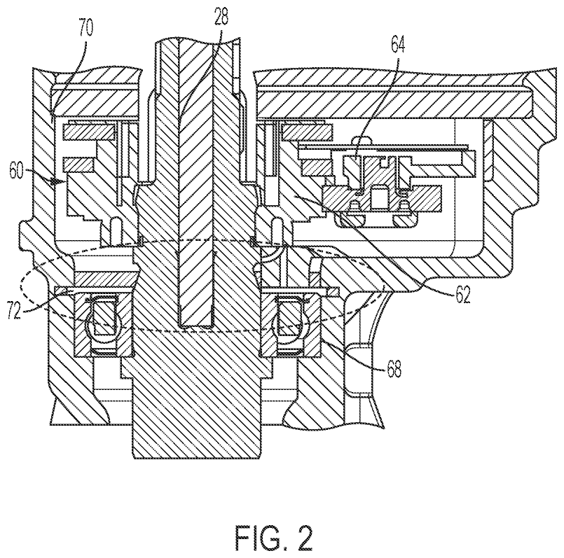

FIG. 2 shows a lower rotor assembly 60 for a torque sensor according to an embodiment of the present disclosure. The torque sensor may be the torque sensor as described in connection with FIG. 1, which may be used in a REPS system of a vehicle to detect a steering torque input to a steering wheel by an operator of the vehicle. The lower rotor assembly 60 is mounted to the pinion shaft 28. A probe housing assembly 64 contains a probe that detects an electric or magnetic field generated during rotation of the lower rotor assembly 60. A bearing 68 is in contact with a portion of the pinion shaft 28. The lower rotor assembly 60 and bearing 68 and shaft 28 are located within a rack housing 70. The bearing 68 is held in place at least partially with a snap ring 72. The snap ring 72 also de-lashes the overall pinion shaft assembly.

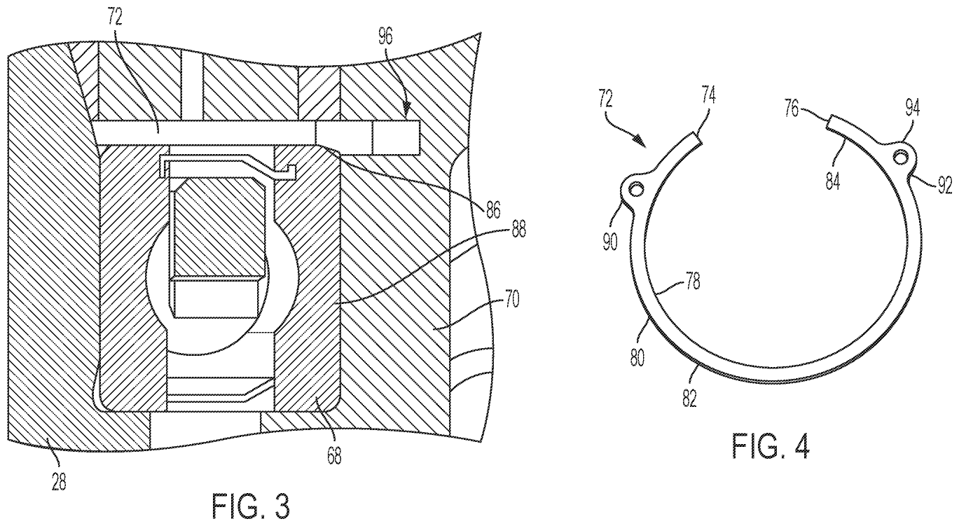

Referring now to FIG. 3, an enlarged portion of FIG. 2 is shown. In particular, a portion of the bearing 68 and the snap ring 72 are shown in greater detail. FIG. 4 shows the snap ring 72 in a perspective view to illustrate additional details of the snap ring 72.

The snap ring 72 is substantially circular, with a break forming a gap between a first end 74 of the snap ring 72 and a second end 76 of the snap ring 72 to define a length of the snap ring 72. The snap ring 72 extends from a radially inner edge 78 to a radially outer edge 80 to define a radial width of the snap ring 72. The snap ring 72 also extends from a first side 82 to a second side 84 to define a thickness of the snap ring 72. The snap ring 72 has a beveled portion 86 on the second side 84 of the snap ring 72. The beveled portion 86 is in contact with an outer race 88 of the bearing 68. The contact between the beveled portion 86 and the outer race 88 holds the bearing 68 in place. The beveled portion 86 is an angled portion which allows the snap ring 72 to press the bearing 68 radially inward and downward/forward in a direction of vehicle.

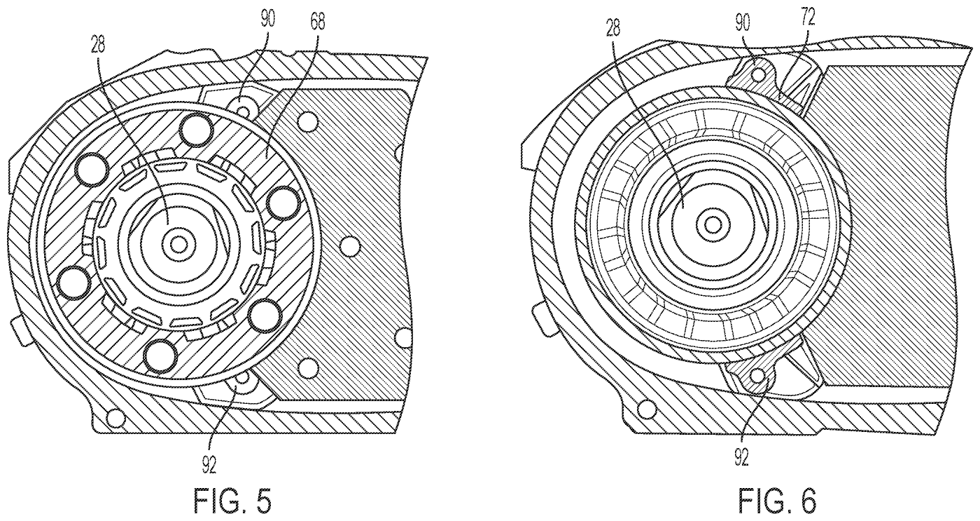

The snap ring 72 includes at least one ear portion protruding radially outward from the radially outer edge 80 of the snap ring 72. In the illustrated embodiment, a pair of ear portions are shown, specifically a first ear portion 90 and a second ear portion 92. The ear portions 90, 92 may be formed of various contemplated shapes which may differ from the illustrated geometry. Regardless of the particular geometry, each ear portion 90, 92 defines a hole 94 which allows a tool to be inserted therein to facilitate manipulation of the snap ring 72 while in an installed condition. In particular, the snap ring 72 may be biased radially outward from a “working” condition (FIG. 5) to an “open” position (FIG. 6). In the working condition of FIG. 5, the snap ring 72 is pressing the bearing 68 radially inward and downward/forward in a direction of the vehicle, as described above. In the open position of FIG. 6, the snap ring 72 is manipulated to a position that allows the bearing 68 to be pushed in for installation or pulled out for removal, while avoiding the need to damage other components.

A portion of the snap ring 72, including the radially outer edge 80, is disposed within a groove 96 defined by the rack housing 70. The groove 96 provides room for the ear portions 90. 92 and for flexure of the snap ring 72 during the opening process described in detail herein.

The snap ring 72 disclosed herein allows for a tool to open the snap ring 72 in a small space, which avoids scrapping other components for a bearing removal process.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A vehicle steering assembly comprising:
a rack which is translatable and disposed within a rack housing;
a pinion shaft operatively coupled to the rack;
a bearing in contact with the pinion shaft and disposed within the rack housing; and
a snap ring partially disposed within a groove defined by the rack housing, the snap ring in contact with the bearing in a first condition, the snap ring having an ear portion defining a hole, wherein the snap ring is moveable from the first condition to a second condition, the first condition pressing the bearing to hold the bearing in place, the second condition allowing the bearing to be removed from the rack housing.

2. The vehicle steering assembly of claim 1, wherein the snap ring includes a beveled portion in contact with a beveled portion on an outer race of the bearing.

3. The vehicle steering assembly of claim 1, wherein the ear portion is a first ear portion, the snap ring further comprising a second ear portion.

4. The vehicle steering assembly of claim 2, wherein the snap ring is substantially circular.

5. The vehicle steering assembly of claim 4, wherein the snap ring extends from a first end to a second end to define a length of the snap ring.

6. The vehicle steering assembly of claim 4, wherein the snap ring extends from a radially inner edge to a radially outer edge to define a radial width of the snap ring.

7. The vehicle steering assembly of claim 4, wherein the snap ring extends from a first side to a second side to define a thickness of the snap ring.

8. The vehicle steering assembly of claim 7, wherein the beveled portion of the snap ring is on the second side of the snap ring.

9. A vehicle steering assembly comprising:
a rack which is translatable and disposed within a rack housing;
a pinion shaft operatively coupled to the rack;
a bearing in contact with the pinion shaft and disposed within the rack housing; and
a snap ring partially disposed within a groove defined by the rack housing, the snap ring in contact with the bearing in a first condition, the snap ring including a beveled portion in contact with a beveled portion on an outer race of the bearing.

10. The vehicle steering assembly of claim 9, wherein the snap ring is substantially circular.

11. The vehicle steering assembly of claim 10, wherein the snap ring extends from a first end to a second end to define a length of the snap ring.

12. The vehicle steering assembly of claim 10, wherein the snap ring extends from a radially inner edge to a radially outer edge to define a radial width of the snap ring.

13. The vehicle steering assembly of claim 10, wherein the snap ring extends from a first side to a second side to define a thickness of the snap ring.

14. The vehicle steering assembly of claim 13, wherein the beveled portion of the snap ring is on the second side of the snap ring.

15. The vehicle steering assembly of claim 9, wherein the snap ring includes an ear portion defining a hole, wherein the snap ring is moveable from the first condition to a second condition, the first condition pressing the bearing to hold the bearing in place, the second condition allowing the bearing to be removed from the rack housing.

16. The vehicle steering assembly of claim 15, wherein the ear portion is a first ear portion, the snap ring further comprising a second ear portion.
